(19) United States
(12) Patent Application Publication
(10) Pub. No.: US 2015/0052261 A1
(43) Pub. Date: Feb. 19, 2015

(54) NETWORK CONNECTION CONTROLLING DEVICE AND METHDO FOR CONTROLLING NETWORK CONNECTION

(71) Applicant: POWER-ALL NETWORKS LIMITED, Shatin (HK)

(72) Inventors: FRANK YEXUN OU, Santa Clara, CA (US); MENG-MING HUANG, Shenzhen (CN); LIU-PING ZHOU, Shenzhen (CN)

(21) Appl. No.: 14/461,449

(22) Filed: Aug. 18, 2014

(30) Foreign Application Priority Data
Aug. 19, 2013 (CN) 2013103611182

(51) Int. Cl. H04L 12/721

(52) U.S. Cl. CPC H04L 45/123
USPC 709/241

(57) ABSTRACT

A method for controlling network connection includes: receiving a network accessing task generated by the user via a corresponding terminal device, the network accessing task is a task of accessing a target source. Detecting work parameters of each network accessing path, the work parameters of each network accessing path includes a workload of the network accessing path and a network operator providing the network accessing path. Selecting an optimal network accessing path according to the detected work parameters of each network accessing path based on a workload tactics. In additional, controlling the terminal device to connect the network to execute the network task via the optimal network accessing path.

### CROSS-REFERENCE TO RELATED APPLICATIONS

This application claims priority to Chinese Patent Application No. 201310361118.2 filed on Aug. 19, 2013 in the China Intellectual Property Office, the contents of which are incorporated by reference herein.

### FIELD

The present disclosure relates to devices, and particularly to a network connection controlling device and a method thereof.

### BACKGROUND

Electronic devices, such as mobile phones and tablet computers, can communicate with each other via corresponding networks, such as the Internet, a code division multiple access (CDMA) network, or a broadcasting network. A network bandwidth is assigned by a corresponding network operator to the electronic devices.

### BRIEF DESCRIPTION OF THE DRAWINGS

Implementations of the present technology will now be described, by way of example only, with reference to the attached figures.

FIG. 1 is a block diagram of an embodiment of a network connection controlling device.

FIG. 2 is a flowchart diagram of an embodiment of a method for controlling network connection.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The term “coupled” is defined as connected, whether directly or indirectly through intervening components, and is not necessarily limited to physical connections. The connection can be such that the objects are permanently connected or releasably connected.

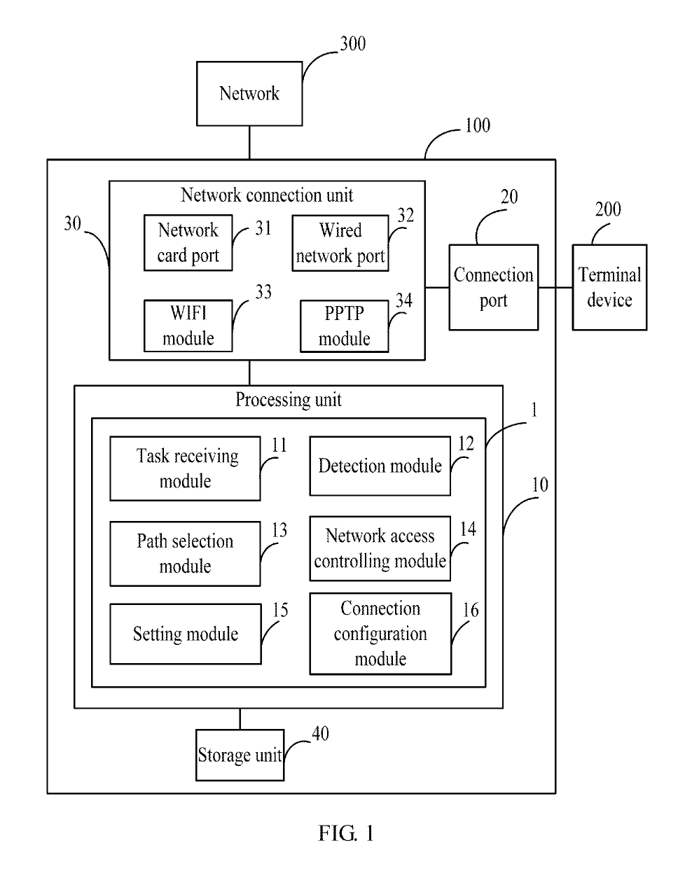

Referring to FIG. 1, a network connection controlling device 100 is illustrated. The network connection controlling device 100 is coupled to at least one terminal device 200, and is used to control the terminal device 200 to connect a network. In the embodiment, the network is an Internet.

The network connection controlling device 100 includes a processing unit 10, at least one connection port 20, a network connection unit 30, and a storage unit 40. The at least one connection port 20 are used to respectively couple to the at least terminal device 200 via a wireless mode or a wired mode.

The network connection unit 30 is used to generate a number of network accessing path in response to a connection and configuration operation of a user. In the embodiment, the network connection unit 30 includes at least one network connection module including but not limited to, a network card port 31, a wired network port 32, a WIFI module 33, and a point to point tunneling protocol (PPTP) module 34.

The network card port 31 is used to connect to a network card, such as the 3rd generation telecommunication (3G) network card, and then connect to the network 300 via the 3G network card. The wired network port 32 is used to connect to a network cable and then connect to the network 300 via the network cable. The WIFI module 33 is used to connect to a WIFI hotspot and then connect to the network 300 via the WIFI hotspot. The PPTP module 34 is used to couple to a PPTP server (not shown) and then connect to the network 300 via the PPTP server.

Each network connection module of the network connection unit 30 can establish at least one network accessing path, for example, the network card port 31 can connect to a number of 3G network cards, and each 3G network card provides a network accessing path for accessing the network 300. Obviously, each network accessing path is provided by a corresponding network operator.

The processing unit 10 is used to run a network connection controlling system 1, the network connection controlling system 1 includes a task receiving module 11, a detection module 12, a path selection module 13, and a network access controlling module 14. The modules of the network connection controlling system 1 are a collection of software instructions stored in the storage unit 40 and executed by the processing unit 10. In one embodiment, the processing unit 10 can be a central processing unit, a digital signal processor, or a single chip, for example. In one embodiment, the storage unit 40 can be an internal storage system, such as a flash memory, a random access memory (RAM) for temporary storage of information, and/or a read-only memory (ROM) for permanent storage of information. The storage unit 40 can also be a storage system, such as a hard disk, a storage card, or a data storage medium. In at least one embodiment, the storage unit 40 can include two or more storage devices such that one storage device is a memory and the other storage device is a hard drive. Additionally, one or more of the storage devices can be located external relative to the network connection controlling device 100.

The task receiving module 11 is used to receive a network accessing task generated by the user via the corresponding terminal device 200. The network accessing task is a task of accessing a target source, includes and is not limited to, a task for browsing a target source, such as a webpage or media files, or a task for downloading the target source from the network. In the embodiment, the network accessing task includes information of a network operator providing the target source, namely the network operator that the target source belonged to.

The detection module 12 is used to detect work parameters of each network accessing path. The work parameters of each network accessing path include a workload of the network accessing path and the network operator providing the network accessing path.

The path selection module 13 is used to select an optimal network accessing path according to the detected work parameters of each network accessing path based on a workload tactics.

The network access controlling module 14 is used to control the terminal device 200 connected to the network connection controlling device 100 to connect the network to execute the network task via the optimal network accessing path. For example, the network access controlling module 14 controls the terminal device 200 to browse the webpage, the videos, or download the media files via the optimal network accessing path.

As described above, the work parameters of each network accessing path includes a workload of the network accessing path and the network operator providing the network accessing path. In the embodiment, the workload of each network accessing path is a network utilization ratio of the network accessing path. The network utilization ratio is the ratio of current network traffic to the maximum network traffic that the network accessing path can handle. When more data is transmitted/received by the network accessing path, the network utilization ratio is great, and the workload of the network accessing path is heavy. For example, if the network utilization ratio of one network accessing path is 85%, then the workload of the network accessing path is 85%.

The network operator of the network accessing path means the network operator providing the network accessing path. For example, if a 3G network card is produced by a network operator “A”, when accessing the network via the 3G network card, the network accessing path via the 3G network card is provided by the network operator “A”.

In the embodiment, the workload tactics includes an optimal compatible tactics, based on the optimal compatible tactics, the path selection module 13 selects the optimal network accessing path according to the work parameters (i.e., the workload and the network operator) of each network accessing path includes: the path selection module 13 determines which network accessing paths are belonged to the network operator providing the target source, and compares the workloads of the determined network accessing paths to a first predetermined workload (for example 85%). The path selection module 13 then selects the determined network accessing path whose workload is less than the first predetermined workload as the optimal network accessing path.

As described above, each network accessing path is provided by a corresponding network operator. For example, when accessing the network via the 3G network card of the network operator “A”, then the network accessing path is provided by the network operator “A”, when accessing the network via the 3G network card of the network operator “B”, then the network accessing path is provided by the network operator “B”. Correspondingly, the target source is also provided by a corresponding network operator. Usually, when accessing the target source provided by one network operator via the network accessing path provided by the same network operator, an access speed would be more quickly. Therefore, in the present disclosure, the path selection module 13 selects the network accessing path whose workload is less than the first predetermined workload and belonged to the network operator providing the target source as the optimal network accessing path, which enhances the access speed.

In the embodiment, the network connection controlling system 1 further includes a setting module 15. The setting module 15 is used to set a weight value of each network connection path configured in/established by the network connection controlling device 100 in response to user operation. In detail, the user can access a configuration interface of the network connection controlling device 100 via the terminal device 200, the setting module 15 set a weight value of each network connection path in response to operations on the configuration interface by the user.

In the embodiment, when the path selection module 13 determines there is more than one network accessing paths whose workload is less than the first predetermined workload and belonged to the network operator providing the target source, namely, there are many optimal network accessing paths, the path selection module 13 chooses the network accessing path with the maximum weight value as the optimal network connection path. In another embodiment, when the path selection module 13 determines there is more than one network accessing paths whose workload is less than the first predetermined workload and belonged to the network operator providing the target source, namely, there are many optimal network accessing paths, the path selection module 13 chooses one network accessing path randomly as the optimal network connection path.

In further another embodiment, when the path selection module 13 determines there is more than one network accessing paths whose workload is less than the first predetermined workload and belonged to the network operator providing the target source, namely, there are many optimal network accessing paths, the path selection module 13 chooses one network accessing path with the least workload as the unique optimal network connection path.

In the embodiment, the workload tactics further includes an optimal workload tactics, based on the optimal workload tactics, the path selection module 13 selects the optimal network accessing path according to the work parameters of each network accessing path includes: the path selection module 13 compares the workloads of all of the network accessing paths to the first predetermined workload, and determines which network accessing paths with the workload less than the first predetermined workload. The path selection module 13 then compares the workloads of the determined network accessing paths to a second predetermined workload (for example 70%), and then selects the determined network accessing path whose workload is less than the second predetermined workload as the optimal network accessing path.

In the embodiment, if there are more than one network accessing path whose workload is less than the second predetermined workload, namely, if there are many optimal network accessing paths, the path selection module 13 first selects the network accessing path belonging to the network operator providing the target source as the optimal network accessing path.

In the embodiment, if there is more than one network accessing path whose workload is less than the second predetermined workload and belongs to the network operator providing the target source, namely, there are many optimal network accessing paths, the path selection module 13 selects the network accessing path with the maximum weight value as the unique optimal network accessing path.

In the embodiment, the network connection controlling system 1 further includes a connection configuration module 16. The connection configuration module 16 is used to control the network connection unit 30 to establish each network accessing path in response to user operation. For example, the connection configuration module 16 configures and starts up the network card port 31 when the user inserts a network card into the network card port 31. The connection configuration module 16 also can configure and start up the WIFI module 33 or/and the PPTP module 34 in response to operations on a control interface of the network connection controlling device 100 after the user logins the control interface of the network connection controlling device 100.

In the embodiment, the network connection controlling device 100 can be a router.

Therefore, according to the present disclosure, when there is a new network accessing task generated by the user via the corresponding terminal device 200, the network connection controlling device 100 can select the optimal network accessing path from the network accessing paths established by the network connection controlling device 100, which enhances the access speed. Accordingly, when there are many network accessing tasks generated by the user at the same time, the network connection controlling device 100 can select different network accessing paths to achieve the different network accessing tasks, which also enhances the access speed.

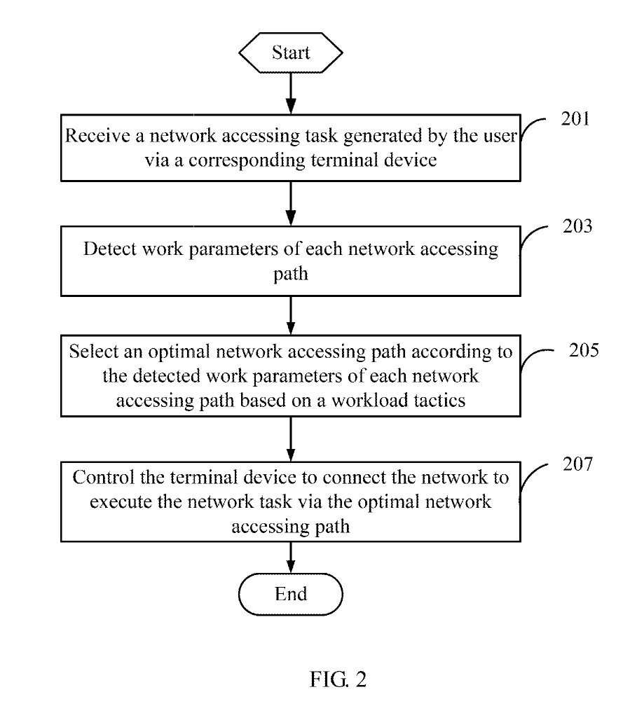

FIG. 2 illustrates a flowchart of a method for controlling network connection.

In block 201, a task receiving module receives a network accessing task generated by a user via a corresponding terminal device, the network accessing task is a task of accessing a target source, and the target source is provided by a corresponding network operator.

In block 203, a detection module detect work parameters of each network accessing path, the work parameters of each network accessing path includes a workload of the network accessing path and the network operator providing the network accessing path.

In block 205, a path selection module selects an optimal network accessing path according to the detected work parameters of each network accessing path based on a workload tactics. In one embodiment, the workload tactics includes an optimal compatible tactics, based on the optimal compatible tactics, the path selection module 13 determines which network accessing paths are belonged to the network operator providing the target source, and compares the workloads of the determined network accessing paths to a first predetermined workload (for example 85%). The path selection module 13 then selects the determined network accessing path whose workload is less than the first predetermined workload as the optimal network accessing path. In another embodiment, the workload tactics includes an optimal workload tactics, based on the optimal workload tactics, the path selection module 13 compares the workloads of all of the network accessing paths to the first predetermined workload, and determines which network accessing paths with the workload less than the first predetermined workload. The path selection module 13 then compares the workloads of the determined network accessing paths to a second predetermined workload (for example 70%), and then selects the determined network accessing path whose workload is less than the second predetermined workload as the optimal network accessing path.

In block 207, the network access controlling module 14 controls the terminal device connected to the network connection controlling device to connect the network to execute the network task via the optimal network accessing path.

In the embodiment, the method can further include: a network connection unit is generates a number of network accessing path in response to a connection and configuration operation of the user.

The method can further include: a setting module sets a weight value of each network connection path configured in/established by the network connection controlling device in response to user operation; when the path selection module determines there are many optimal network accessing path, the path selection module selects the network accessing path with the maximum weight value as the unique optimal network accessing path.

The method can further include: when the path selection module determines there are many optimal network accessing path, the path selection module selects one network accessing path as the unique optimal network accessing path randomly.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A network connection controlling device comprising:
at least one connection port configured to connect to at least one terminal device;
a network connection unit configured to generate a plurality of network accessing paths in response to a connection and configuration operation of a user; and
at least one processing unit configured to execute a plurality of modules which are collection of instructions, the modules comprising:
a task receiving module configured to receive a network accessing task generated by the user via the corresponding terminal device, wherein the network accessing task is a task of accessing a target source, and the target source is provided by a corresponding network operator;
a detection module configured to detect work parameters of each network accessing path;
a path selection module configured to select an optimal network accessing path according to the detected work parameters of each network accessing path based on a workload tactics; and
a network access controlling module configured to control the terminal device to connect the network to execute the network task via the optimal network accessing path.

2. The device according to claim 1, wherein the work parameters of each network accessing path comprises a workload of the network accessing path and a network operator providing the network accessing path.

3. The device according to claim 2, wherein the workload tactics comprises an optimal compatible tactics; based on the optimal compatible tactics, the path selection module determines which network accessing paths are belonged to the network operator providing the target source, and compares the workloads of the determined network accessing paths to a first predetermined workload, and then selects the determined network accessing path whose workload is less than the first predetermined workload as the optimal network accessing path.

4. The device according to claim 3, wherein the modules further includes a setting module configured to set a weight value of each network connection path in response to user operation; when the path selection module determines there is more than one network accessing paths whose workload is less than the first predetermined workload and belonged to the network operator providing the target source, the path selection module chooses the network accessing path with the maximum weight value as a unique optimal network connection path.

5. The device according to claim 4, wherein when the path selection module determines there is more than one network accessing paths whose workload is less than the first predetermined workload and belonged to the network operator providing the target source, the path selection module chooses one network accessing path as a unique optimal network connection path randomly.

6. The device according to claim 2, wherein the workload tactics comprises an optimal workload tactics, based on the optimal workload tactics, the path selection module compares the workloads of all of the network accessing paths to the first predetermined workload, and determines which network accessing paths with the workload less than the first predetermined workload; the path selection module then compares the workloads of the determined network accessing paths to a second predetermined workload less than the first predetermined workload, and then selects the determined network accessing path whose workload is less than the second predetermined workload as the optimal network accessing path.

7. The device according to claim 6, wherein if there are more than one network accessing path whose workload is less than the second predetermined workload, the path selection module selects the network accessing path belonging to the network operator providing the target source as the optimal network accessing path in preference to selects the network accessing path belonging to the different network operator as that of the target source.

8. The device according to claim 7, wherein the modules further includes a setting module configured to set a weight value of each network connection path in response to user operation; if there is more than one network accessing path whose workload is less than the second predetermined workload and belongs to the network operator providing the target source, the path selection module chooses the network accessing path with the maximum weight value as a unique optimal network connection path.

9. A method for controlling network connection comprising:
receiving a network accessing task generated by the user via a corresponding terminal device, wherein the network accessing task is a task of accessing a target source provided by a corresponding network operator;
detecting work parameters of each network accessing path;
selecting an optimal network accessing path according to the detected work parameters of each network accessing path based on a workload tactics; and
controlling the terminal device to connect the network to execute the network task via the optimal network accessing path.

10. The method according to claim 9, wherein the workload tactics comprises an optimal compatible tactics; the work parameters of each network accessing path comprises a workload of the network accessing path and a network operator providing the network accessing path; the step of selecting an optimal network accessing path according to the detected work parameters of each network accessing path based on a workload tactics comprises:
determining which network accessing paths are belonged to the network operator providing the target source;
comparing the workloads of the determined network accessing paths to a first predetermined workload; and
selecting the determined network accessing path whose workload is less than the first predetermined workload as the optimal network accessing path.

11. The method according to claim 9, wherein the workload tactics comprises an optimal workload tactics, the step of selecting an optimal network accessing path according to the detected work parameters of each network accessing path based on a workload tactics comprises:
comparing the workloads of all of the network accessing paths to the first predetermined workload;
determining which network accessing paths with the workload less than the first predetermined workload;
comparing the workloads of the determined network accessing paths to a second predetermined workload less than the first predetermined workload; and
selecting the determined network accessing path whose workload is less than the second predetermined workload as the optimal network accessing path.

12. The method according to claim 9, further comprising:
generating a plurality of network accessing paths in response to a connection and configuration operation of the user.

13. The method according to claim 9, further comprising:
setting a weight value of each network connection path in response to user operation; and
selecting the network accessing path with the maximum weight value as a unique optimal network accessing path when the path selection module determines there are many optimal network accessing paths.

14. A non-transitory storage medium having stored thereon instructions that, when executed by at least one processor of a computing device, causes the least one processor to execute instructions of a method for automatically testing signal integrity of an electronic product, the method comprising:
receiving a network accessing task generated by the user via a corresponding terminal device, wherein the network accessing task is a task of accessing a target source provided by a corresponding network operator;
detecting work parameters of each network accessing path;
selecting an optimal network accessing path according to the detected work parameters of each network accessing path based on a workload tactics; and
controlling the terminal device to connect the network to execute the network task via the optimal network accessing path.

15. The non-transitory storage medium according to claim 14, wherein the workload tactics comprises an optimal compatible tactics; the work parameters of each network accessing path comprises a workload of the network accessing path and a network operator providing the network accessing path; the step of selecting an optimal network accessing path according to the detected work parameters of each network accessing path based on a workload tactics comprises:
determining which network accessing paths are belonged to the network operator providing the target source;
comparing the workloads of the determined network accessing paths to a first predetermined workload; and
selecting the determined network accessing path whose workload is less than the first predetermined workload as the optimal network accessing path.

16. The non-transitory storage medium according to claim 14, wherein the workload tactics comprises an optimal workload tactics, the work parameters of each network accessing path comprises a workload of the network accessing path and a network operator providing the network accessing path; the step of selecting an optimal network accessing path according to the detected work parameters of each network accessing path based on a workload tactics comprises:
comparing the workloads of all of the network accessing paths to the first predetermined workload;
determining which network accessing paths with the workload less than the first predetermined workload;
comparing the workloads of the determined network accessing paths to a second predetermined workload less than the first predetermined workload; and
selecting the determined network accessing path whose workload is less than the second predetermined workload as the optimal network accessing path.

17. The non-transitory storage medium according to claim 14, wherein the method further comprising:
generating a plurality of network accessing paths in response to a connection and configuration operation of the user.

18. The system according to claim 14, wherein the method further comprising:
setting a weight value of each network connection path in response to user operation; and
selecting the network accessing path with the maximum weight value as a unique optimal network accessing path when the path selection module determines there are many optimal network accessing paths.
